(19) United States
(12) Patent Application Publication
(10) Pub. No.: US 2005/0287057 A1
(43) Pub. Date: Dec. 29, 2005

(54) Converting sulfur dioxide to sulfur trioxide in high-concentration manufacturing, using activated carbon with dopants and stripping solvent

(76) Inventor: Alan K. Richards, Houston, TX (US)

Correspondence Address: Patrick D. Kelly, 11939 Manchester #403, St. Louis, MO, 63131, US

(21) Appl. No.: 11/157,695

(22) Filed: Jun. 21, 2005

Related U.S. Application Data
(60) Provisional application No. 60/581,750, filed on Jun. 21, 2004.
(60) Provisional application No. 60/651,353, filed on Feb. 8, 2005.

(51) Int. Cl. C01B 17/00

(52) U.S. Cl. 423/242.1

(57) ABSTRACT

Methods, devices, and materials are disclosed for efficient high-volume oxidation of SO₂ to SO₃, for bulk manufacturing rather than exhaust scrubber operations. Activated carbon, with vanadium or other catalytic dopants, is used, and an anhydrous solvent with a low dielectric constant, minimal hydrogen bonding, and potent SO₃ stripping ability is used. Vanadium compounds such as vanadium diformate, and catalyst formulations using metals that can alternate back and forth between +4 and +6 oxidation states (such as tungsten or molybdenum), can increase efficiency. A process that uses hydroxy radicals to initiate a chain reaction that converts SO₂ to SO₃ also is disclosed.

### RELATED APPLICATIONS

This application claims the benefit under 35 USC 119(e) of U.S. provisional applications 60/581,750 (filed Jun. 21, 2004) and 60/651,353 (filed Feb. 8, 2005).

### FIELD OF THE INVENTION

This invention relates to sulfur chemistry, organic chemistry, and catalytic materials.

### BACKGROUND OF THE INVENTION

New methods for converting methane gas into methanol and other compounds have been disclosed in published Patent Cooperation Treaty applications WO 2004/041399 and 2005/044789, both by the same Inventor-Applicant herein. The contents of those applications are incorporated by reference, as though fully set forth herein.

Briefly, that system involves using a radical-initiated reaction to bond methane gas to sulfur trioxide (SO₃), forming methane-sulfonic acid (MSA). MSA is useful for certain manufacturing processes, but those uses are limited. Therefore, the main uses for MSA arise from the following: (i) it can be “cracked” at high temperature, to release methanol, a liquid that can be shipped via tankers, pipelines, etc.; or, (ii) it can be processed in other ways to form valuable compounds such as olefins, dimethyl ether, and liquid fuels.

MSA cracking or processing treatments will release sulfur dioxide, SO₂. The SO₂ must be oxidized (or regenerated, recycled, etc.) back into SO₃, so the SO₃ can be pumped back into the reactor that forms MSA. This closed cycle, for the sulfur, can avoid and minimize the formation of toxic and hazardous wastes. For convenience, this oxidation process is referred to herein as SO2-3 oxidation.

The methane-to-MSA process appears to be highly efficient, with yields over 95%. Therefore, it offers major improvements over other methods (such as liquefied natural gas, Fischer-Tropsch processing, etc.) for converting “stranded” or “remote” methane gas into liquids that can be stored and shipped, efficiently and economically, across an ocean or desert. Since stranded methane currently is being wasted in huge quantities (an estimated $100 million worth of methane is burned in flares, or reinjected into the ground, every day), this new process is likely to create worldwide changes in how methane is processed and used.

However, the huge volumes of methane gas that need to be processed will lead to major challenges in continuously recycling SO₂ byproducts back into SO₃ feedstocks, at high rates and in extremely large volumes.

Sulfuric acid (H₂SO₄) is the most widely used commodity chemical in the world. It is usually manufactured by burning elemental sulfur to get SO₂, then oxidizing the SO₂ to SO₃, then combining the SO₃ with water. In nearly all of those manufacturing operations, the SO2-3 oxidation step uses vanadium pentaoxide, V₂O₅, as a catalyst, in tall towers (frequently 40 to 50 feet tall) made of expensive alloys that can withstand concentrated sulfuric acid.

This type of conventional SO2-3 oxidation has been described in publications such as U.S. Pat. No. 6,521,200 (Silveston et al 2003). The following excerpts, from column 1 of that patent, provide a good summary of the types of processing and equipment that are used in the conventional prior art methods: “Oxidation of sulphur dioxide is a highly exothermic reaction, and the currently preferred catalysts are active only at high temperatures, e.g., about 450-550° C. The preferred catalysts are a eutectic mixture of vanadium pentoxide and potassium pyrosulphate supported on titanium dioxide, alumina, silica or minerals such as kieselguhr. Since the reaction is reversible and exothermic, the reactor usually consists of four trays in series that are operated adiabatically, in order to enhance the overall conversion.

The catalyst layers are typically from about 15 to 50 cm deep, and consequently the cost of the catalyst is a large portion of the cost of the loaded reactor. For example, a plant that produces 1,000 tonnes of [sulfuric] acid per day may contain 150,000 to 200,000 liters of catalyst. The sulphur trioxide formed is dissolved in 98% sulphuric acid. If attempts are made to dissolve SO₃ directly into water or into a weaker acid, the water vapour pressure causes the formation of an acid mist that is difficult to remove. The fortified H₂SO₄ that is obtained may then be diluted to the desired strength. In order to meet air pollution requirements, the gas leaving the scrubber must be further treated, which adds another expensive step.”

Like quite a few other teams of researchers, the inventors of U.S. Pat. No. 6,521,200 (a team of researchers led by Prof. Robert Hudgins at the University of Waterloo, in Canada) were trying to develop improved ways for removing SO₂ from the exhaust gases (also called flue gases) that are emitted by large factories and electrical power plants. Similar efforts are discussed in articles such as Carabineiro et al 2003, and in roughly 30 additional articles cited therein.

Because of the crucial importance of mass transfer and heat transfer rates in the SO2-3 oxidation process, prior art processes that are designed and adapted for capturing, converting, and removing low concentrations of SO₂ in exhaust gases, using pollution control equipment, are very different from rapid oxidation of SO₂ in high concentrations, and large quantities, in a manufacturing operation. As an illustration, Carabineiro et al 2003 described a system that was tested for removal of SO₂ at levels that ranged from 41 to 208 micro-moles of SO₂ per “dm³” of gas (presumably, dm³ refers to 10 cubic meters of gas, under standard atmospheric conditions).

The importance of mass and heat transfer rates, in assessing the differences between low-concentration exhaust gas scrubbing versus high-concentration manufacturing, become especially important in the SO2-3 oxidation process, because a number of factors limit the efficiencies and increase the costs of SO2-3 oxidation reactors. As an illustration, activated carbon is the primary material of interest for absorbing SO₂ from exhaust gases, in pollution control equipment that handles low concentrations of SO₂. This arises from the fact that the jagged surfaces of activated carbon tend to help split apart O₂ molecules, creating “singlet” oxygen, which then reacts with SO₂. However, activated carbon has been unable to compete effectively against V₂O₅ catalysts in high-concentration manufacturing operations, largely because of two factors. At temperatures less than about 200° C., SO₃ will bind to activated carbon, in a manner that impedes the removal of the product from the surfaces of the material where it was formed, and from the reactor (this type of binding action also hinders additional SO₂ from reaching the catalytic surface). If operating temperatures are increased to higher levels, the SO₃ can release more rapidly from the activated carbon surfaces, but other problems arise because the SO2-3 oxidation reaction becomes reversible, causing the desired SO₃ product to be reduced back to the unwanted SO₂ starting material, when high temperatures are used.

To avoid those types of problems, which hinder the use of activated carbon in high-concentration manufacturing operations, manufacturing operations generally have avoided the use of activated carbon, and instead have settled on the use of molten vanadium complexes that include alkali salts such as potassium pyrosulfate. To avoid precipitation of certain vanadium sulfate compounds, those catalytic reactors must operate above 420° C., which is about 750° F.

U.S. Pat. No. 6,521,200 (Silveston et al 2003), mentioned above, describes an effort to overcome the SO₃ binding problems that have limited the use of activated carbon in SO2-3 oxidation processing. That effort involved the use of various types of organic solvents (such as ketones, ethers, tetrahydrofurans, etc.) to strip the SO₃ off of the activated carbon. That effort led to various additional tactics, such as using a hydrophobic polymer (such as poly-tetrafluoro-ethylene, or PTFE, sold under the trademark TEFLON™) as a physical binding agent, to manipulate and handle the activated carbon pellets or powders. The use of TEFLON binders apparently minimized the formation of liquid films on the surfaces of the activated carbon, which was useful, since liquid films can impede the ability of SO₂ gas to reach the surface of the activated carbon.

However, a subsequent report by the same researchers, Wattanakasemtham et al 2005 (electronically published as item 10.1021/ie0401861 on the American Chemical Society website in February 2005, scheduled for publication in the Journal of the American Chemical Society on Aug. 3, 2005) disclosed that unwanted reactions were taking place in their system, as shown by degradation of their organic solvents, and discoloration of the products.

It should be noted that Carabineiro et al 2003, mentioned above, studied the effects of “doping” activated carbon with various metals, including copper, iron, vanadium, nickel, etc., and two-component mixtures of those metals. It reported that vanadium and vanadium-copper dopants caused the highest increases in SO₂ absorption levels, on treated activated carbon. However, that report was limited to absorption levels only; it did not discuss, and apparently the researchers made no effort to analyze, the conversion of absorbed SO₂ into SO₃, or the removal of SO₃ from the activated carbon.

For completeness, it should also be noted that various proposals also have been made for alternate approaches to SO2-3 oxidation. As one example, U.S. Pat. No. 5,264,200 (Felthouse et al 1993) describes the use of monolith reactors that are coated with active catalysts. In this field of chemistry, monoliths are hard but porous materials with essentially linear and parallel flow channels; since the flow channels are essentially linear, monoliths do not cause severe pressure drops. Other inert materials that can provide solid supports for catalytic materials include woven glass fibers (e.g., Bal'zhinimaev et al 2003), and zeolite-type porous materials (e.g., U.S. Pat. No. 6,500,402, Winkler et al 2002).

However, to the best of the Applicant's knowledge and belief, none of those proposals have been adopted by the industry, on any significant scale. The nature of those types of support materials is that they can provide inexpensive inert supporting surfaces, for thin-layer coatings of expensive catalytic compounds. However, sulfuric acid manufacturing has settled on the use of molten vanadium, rather than thin-layer coatings on solid surfaces, and molten compounds are not well-suited for providing thin-layer coatings on monoliths, woven fiberglass, or other inert support materials.

In addition, still other factors have worked against the adoption of any new and innovative proposals, within the sulfuric acid manufacturing industry. One set of issues centers on the fact that large numbers of existing V₂O₅ systems are operating, and have been running for decades. People and companies know how to keep those systems running, and if a system suffers an upset, local operators and available experts know how to get it running again, quickly. Replacement of those existing systems, and training people not just to run them but also to diagnose and correct any upsets and malfunctions, would be very expensive.

A second set of issues centers on the fact that SO2-3 oxidation is highly exothermic. Since it releases a lot of heat and energy, which can be captured and used for steam generation or similar uses, there has been relatively little motivation or incentive for industrial companies that already own and run V₂O₅ systems to invest in other systems that might be smaller, faster, or more efficient.

However, that situation will change dramatically, with the advent of new processes for converting methane to liquids or olefins at high efficiency, and in huge volumes. The development of new radical-initiated systems for converting methane into methane-sulfonic acid (MSA), and then converting the MSA into liquid fuels, olefins, or other valuable products, will require SO2-3 oxidation in volumes and tonnages greater than ever needed previously.

Accordingly, one object of this invention is to disclose methods and catalysts that can be used to improve the efficiency and reduce the costs of SO2-3 oxidation.

Another object of this invention is to disclose methods and catalysts that can enable SO2-3 oxidation in ways that generate less toxic or hazardous waste, using anhydrous systems that avoid or minimize any water or salt formation, and that also minimize sulfuric acid formation.

Another object of this invention is to disclose a processing system that can properly and efficiently utilize the large amounts of energy that will be released when large quantities of SO₂ are oxidized to SO₃.

These and other objects of the invention will become more apparent through the following summary, description, and figures.

### SUMMARY OF THE INVENTION

Methods, devices, and catalytic materials are disclosed for improved oxidation of SO₂ to SO₃ (referred to herein as SO2-3 oxidation). These methods, devices, and materials are designed for oxidizing high-concentration SO₂, such as from an MSA cracking or processing operation. Because of mass and heat transfer factors, high-concentration SO2-3 oxidation poses challenges and obstacles that are very different from the task of removing (scrubbing) SO₂, at very low concentrations, out of exhaust (flue) gases.

The main disclosure herein focuses on activated carbon, with vanadium or other catalytic dopants, as a solid catalytic surface that can provide high rates of SO2-3 absorption and oxidation. Prior problems that impeded the release of newly-formed SO₃ from activated carbon surfaces can be overcome or at least minimized by using an anhydrous liquid with a low dielectric constant and minimal hydrogen bonding, such as supercritical CO₂ or SO₂, or MSA, as a solvent and/or releasing agent (which can also be called a stripping or flushing agent, or similar terms).

Several additional disclosures are also provided herein, even though they are at a stage where they normally should be regarded and treated as provisional disclosures, suited for a provisional application. They are included herein, to ensure that the “disclosure of the best mode” requirement is fully satisfied, since the inventor-applicant contemplates that they may offer the best mode of carrying out the actual commercial-scale oxidation of SO₂ to SO₃. These disclosures include the following:

(1) certain types of vanadium compounds, such as vanadium diformate (in which the hydrogen atoms are replaced by halogens such as fluorine, or other electronegative compounds, if desired) appear to be capable, under at least some conditions, of promoting faster and more efficient SO2-3 oxidation than prior known vanadium compounds such as V₂O₅;

(2) catalyst formulations using transition metals that can alternate back and forth between +4 and +6 oxidation states (such as tungsten or molybdenum) may be able to provide catalytic performance that is superior to other vanadium compounds such as V₂O₅; and,

(3) a process that uses hydroxy radicals to initiate a chain reaction that converts SO₂ to SO₃ also is disclosed.

In addition, processing systems with heat exchangers are disclosed, to enable the heat that is generated and released by SO2-3 oxidation to be used to heat methane-sulfonic acid (MSA). MSA is a major intermediate in the efficient conversion of methane gas into valuable liquids. In several “downstream” processes that use the MSA intermediate as a feedstock, the MSA needs to be heated to elevated temperatures, to enable cracking or conversion to other products. Accordingly, processing systems can use heat exchangers to allow heat from SO2-3 oxidation to directly heat the MSA.

### BRIEF DESCRIPTION OF THE DRAWINGS

FIG. 1 depicts a series of computer-calculated intermediates that may enable a vanadium diformate catalyst to facilitate oxidation of SO₂ to SO₃ with reduced energy barriers.

FIG. 2 depicts a computer-calculated pathway for oxidizing SO₂ to SO₃, catalyzed by a transition metal (such as molybdenum or tungsten) that can alternate between +4 and +6 oxidation states.

FIG. 3 depicts a computer-calculated pathway for oxidizing SO₂ to SO₃, using hydroxy radicals (which can be obtained from sources such as hydrogen peroxide) to initiate a chain reaction that will convert SO₂ to SO₃ is disclosed.

FIG. 4 is a graph depicting the Gibbs free energy values for the various steps in the radical-initiated pathway depicted in FIG. 3.

FIG. 5 is a schematic depiction of a hardware system for SO2-3 oxidation, using: (i) an oxidizing reactor; (ii) a heat exchanger that allows heat from the SO2-3 oxidation to heat MSA to cracking or other elevated temperatures; (iii) an SO₃ condenser, to allow liquid SO₃ to be collected and pumped back into the reactor that combines SO₃ with methane to form MSA; and (iv) a device for separating SO₂ from remnants of the air that was used as an oxygen source, allowing purified SO₂ to be returned to the oxidizing reactor for another pass.

### DETAILED DESCRIPTION

As summarized above, methods, devices, pathways, and catalytic materials are disclosed herein for converting sulfur dioxide into sulfur trioxide (also referred to herein as SO2-3 oxidation), in ways that are smaller, faster, more efficient, and less expensive than other systems currently in use. These methods and pathways can outperform conventional systems that use large processing towers with vanadium pentaoxide (V₂O₅), and they also offer various advantages over more recent systems disclosed in various US patents, including monolith systems such as described U.S. Pat. No. 5,264,200 (Felthouse et al 1993, assigned to Monsanto).

This system is intended for use in high-concentration manufacturing operations, which are different and distinct from other systems that are used to remove low-concentration SO₂ from exhaust gases (also called flue gases). Because mass and heat transfer factors have major effects on these types of reactions, the removal of low-concentration SO₂ from exhaust gases is regarded as substantially different from manufacturing operations that must oxidize SO₂ in high concentrations. Prior art and proposed developments in the field of cleaning exhaust gases, while interesting and potentially instructive in some respects, has not been successfully transferred into the field of manufacturing.

Accordingly, various claims below refer to “a gas containing SO₂ at a concentration of at least about 3% by weight”. That concentration is much higher than the concentrations found in exhaust gases, while most acid manufacturing operations use SO₂ streams that contain at least about 4% (and usually higher) by weight. Accordingly, the 3% concentration level is used herein as a boundary, to distinguish between exhaust gas scrubbing, and bulk SO₃ manufacturing. Any claims that refer to SO₂ concentrations of at least about 3% by weight exclude any exhaust or flue gas scrubbing operations, and are limited instead to SO₃ bulk manufacturing (which includes the manufacture of sulfuric acid from elemental sulfur as a starting material, and the use and recycling of SO₃ and SO₂ as part of an operation that converts methane gas into MSA or other intermediates or products).

Accordingly, the preferred methods and devices for SO2-3 oxidation, as disclosed herein, including the following elements, in combination:

(i) a solid material that has a catalytic surface and that contains at least one type of catalytic metal dopant;

(ii) at least one anhydrous liquid solvent that has a low dielectric constant and that functions as an efficient stripping agent to remove SO₃ product from the catalytic surface;

(iii) a feedgas stream that contains SO₂ at a concentration of at least about 3% by weight;

(iv) an oxygen supply, such as conventional air, or a concentrated or purified oxygen stream; and,

(v) a reactor vessel that is designed to enable rapid entry of the feedgas stream and the oxygen supply into the reactor vessel, and rapid removal of SO₃ product from the reactor vessel, and that is provided with at least one heat exchanger component to enable heat generated by SO2-3 oxidation to be removed efficiently from the reactor vessel and transferred to a liquid that needs to be heated for chemical or power supply purposes.

Each of the phrases listed above requires some clarification and explanation.

The first phrase (“the solid material that has a catalytic surface and that contains at least one type of catalytic metal dopant”) includes activated carbon, which has inherent catalytic activity in oxidation reactions, regardless of whether it also contains a catalytic dopant. Other types of solid materials, including relatively inert ceramic, woven fiberglass, or similar materials, can also be included within that phrase, if the complete material (including the catalytic metal dopant) has catalytic activity.

The reference to “at least one type of catalytic metal dopant” is intended to fall within the terms “catalyst” and “dopant”, as those terms are recognized and used by experts in the field of catalytic chemistry. In general, a catalyst is a compound that helps promote a chemical reaction without being consumed by the reaction, while a dopant is an optional compound that can be coated onto, incorporated within, or otherwise added to any of various types of solid supports. These compounds can provide new catalytic activity to solid materials that previously had no catalytic activity of their own, such as when added to inert ceramic monoliths; alternately or additionally, they can increase (or enhance, promote, etc.) catalytic activity that was already present on a solid material, such as activated carbon.

Based on computer modeling to date, the primary catalytic metal dopants that are interest herein are vanadium, tungsten, or molybdenum compounds or complexes, as discussed in more detail below. Other candidate metal catalysts can be tested and evaluated for use as disclosed herein, using no more than routine experimentation.

Phrases such as “a solid material that has a catalytic surface” (or “a solid catalytic preparation”, as used in the claims) can include any type of porous material (such as cakes, monoliths, woven strands, etc.), and it can also include pellets, powders, or other particulates that may be suspended or stirred in a liquid. However, it does not include molten or other entirely liquid formulations that do not have specific and identifiable solid surfaces.

Phrase (ii) as specified above (“at least one anhydrous liquid solvent that has a low dielectric constant and that functions as an efficient stripping agent to remove SO₃ product from the catalytic surface”) specifically includes supercritical CO₂, supercritical SO₂, and MSA. To facilitate an industrial manufacturing operation, the same liquid that functions as a solvent (which must help increase the solubility and mass transfer rates for SO₂, in the system) must also be able to function as an effective stripping or releasing agent, to help rapidly remove the SO₃ product from the catalytic surface. Those are two different functions, and a portion of the invention herein resides in the discovery and realization that some types of liquids that have low dielectric constants, and low levels of hydrogen bonding, can perform both of those functions. Supercritical CO₂, supercritical SO₂, and MSA are at the top of the list of promising candidates for carrying out those two functions. Other candidate liquids that have low dielectric constants and low levels of hydrogen bonding also can be evaluated for such use.

Phrase (iii) as specified above (“a feedgas stream that contains SO₂ at a concentration of at least about 3% by weight”) is intended to exclude exhaust gases, also called flue gases. As used herein, “exhaust gases” are limited to gases that are created by processes that involve the burning of hydrocarbon fuels. By contrast, a gas that contains SO₂ as a product of burning elemental sulfur (a step used in the manufacture of sulfuric acid) is not classified as an exhaust gas.

Phrase (iv) as specified above (“an oxygen supply, such as conventional air, or a concentrated or purified oxygen stream”) is intended to include any type of gaseous or liquid stream that provides the oxygen atoms that will be used to oxidize SO₂ to SO₃. Conventionally, streams that contain oxygen at a level greater than 20%, and up to about 90%, usually are referred to as concentrated, while streams that contain oxygen at a level greater than about 90% usually are referred to as purified; however, those terms are not always used consistently.

Phrase (v) as specified above (“a reactor vessel . . . ”) refers to any chamber(s) that enclose(s) the catalytic material, and that receives, processes, and releases that gaseous or liquid flow streams that enter and exit the chamber. Reactor vessels (including reactor vessels with heat exchangers) are well-known in the art, and are sold by numerous vendors. Such reactor vessels can be regarded as either including or excluding the various inlet and outlet pipes, fittings, heat exchangers, or other appurtenances that are attached to a chamber.

Accoridngly, those are the essential elements of the system. The invention also comprises a method for oxidizing SO₂ at high concentration into SO₃, comprising the following steps:

a. contacting a gas containing SO₂ at a concentration of at least about 3% by weight, and an oxygen supply, with a solid catalytic preparation that contains at least one type of catalytic metal dopant, in a reactor vessel that also contains at least one anhydrous liquid solvent having a low dielectric constant, under temperature and pressure conditions that promote oxidation of SO₂ molecules to form SO₃ molecules; and,

b. using said anhydrous liquid solvent having a low dielectric constant as a stripping agent to remove SO₃ molecules from the activated carbon preparation.

Candidate Catalysts: Vanadium Formate Compounds

With the assistance of a graduate student who has proper access to a powerful computer, and who is skilled at using sophisticated molecular modeling software (the Amsterdam Density Functional program, release 2.3.3, by Scientific Computation and Modelling (www.scm.com), described in articles such as te Velde et al 2001), the Applicant has carried out computer modeling of a number of candidate vanadium catalysts.

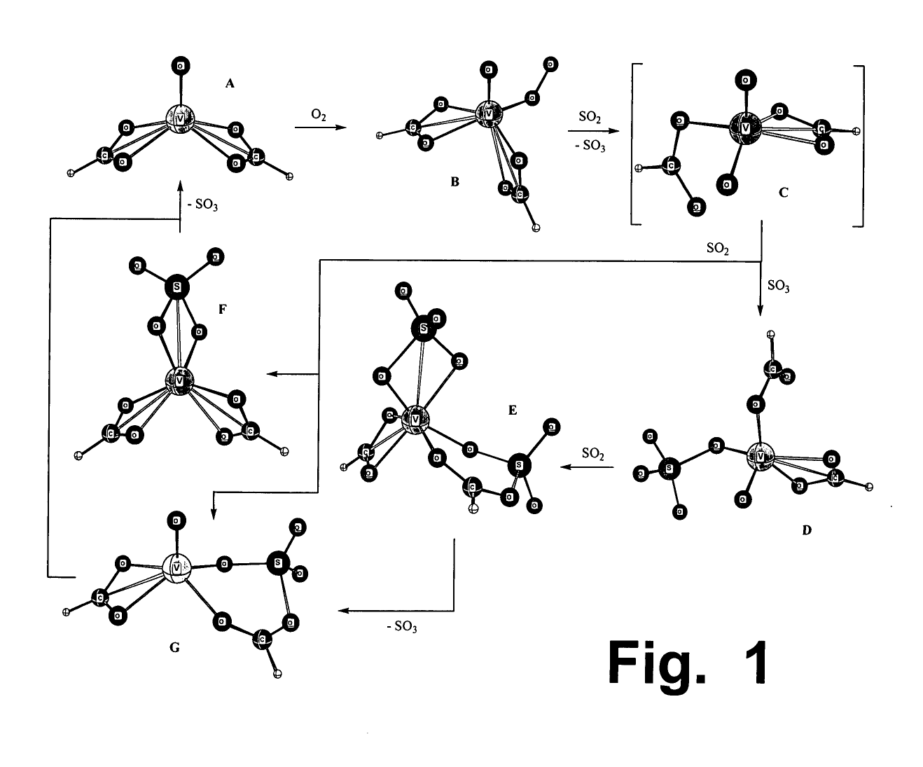

A promising class of materials identified to date includes materials that take vanadium to oxidation states of +4, +5, or possibly even +6. These materials can be created in various ways, such as by using derivatives of formic acid (HCOOH), the smallest organic acid. When reacted with vanadium oxide, the oxygen atoms from the formate residue create complexes in which they have coordinate bonds with both the formate carbon atoms and the vanadium atom, as illustrated by Complex A, the starting material shown in the upper left corner of FIG. 1. Complex A in FIG. 1 shows a basic diformate structure, having a single hydrogen atom bonded to each formate carbon atom, as used for initial modeling purposes. Subsequent modeling indicated that if electronegative atoms such as fluorine are substituted for the hydrogen atoms, the substituted compound may perform even more efficiently.

As indicated in FIG. 1, a vanadyl diformate catalyst can pass through a series of potential intermediate complexes, when used to oxidize SO₂ to SO₃. It should be noted from FIG. 1 that various intermediate complexes provide alternative options and pathways, rather than a single constrained sequence of reactions. For example, Complex C is likely to be converted into some mixture of Complex D, Complex F, and Complex G. The net result of the entire cyclical pathway (with branches) is that the vanadyl diformate compound, in Complex A, will be returned to its original structure, thereby allowing it to serve as a catalyst rather than a consumed reagent.

It should be noted from FIG. 1 that a first oxidation of SO₂ into SO₃ occurs when Complex B is converted into Complex C. A second conversion of another molecule of SO₂ into SO₃ occurs, in the larger overall cycle, in a two-step process: (1) SO₂ is consumed when Complex C is converted into any of Complexes D, F, or G; and, (2) SO₃ is released, when any of Complexes D, F, or G completes the cycle and returns to Complex A.

The calculated thermodynamic values, expressed as changes in enthalpy and Gibbs free energy for the cycle shown in FIG. 1, indicated that: (i) large quantities of heat will be released, since the overall cycle is highly exothermic, as indicated by negative enthalpy values for most of the steps; and, (ii) the Gibbs free energy changes for most steps were either negative (which means those steps in the cycle will proceed spontaneously and quite rapidly), or only mildly positive (which means those barriers can be overcome without great difficulty).

Two other aspects of certain complexes shown in FIG. 1 should also be noted. First, Complex A has an oxidation state of +4, which changes to +5 when O₂ is added, to form Complex B. This step occurs before the +SO₂/−SO₃ reaction that occurs when Complex B is converted into Complex C. This supports the general assertion that vanadium complexes that have +4 oxidation states, and that can be converted into +5 oxidation states, provide promising candidate catalyst materials.

Second, the pendant “double oxygen” structure that is added to the vanadium atom, when Complex B is formed, must either be ionic, or it must be a resonant structure, where the electrons cannot be precisely assigned to specific atoms in the molecule. It is possible that those two coupled oxygen atoms may form a triangular structure, with one of the electrons on the vanadium atom, in a manner that would have two distinct effects: (1) it would generate what may be a +6 oxidation state, on the vanadium; and (2) it would create an exposed and accessible “double oxygen surface” on Complex B, which could be extremely rapid and effective in donating one of those two oxygens to SO₂, to convert it to SO₃ while converting Complex B into Complex C.

The double oxygen structure illustrated in Complex B in FIG. 1 is shown as having only a single bond with the vanadium atom. This would be classified as a “monodentate” complex, using a term familiar to chemists who specialize in catalytic materials. If the double oxygen structure were to bend around and create a triangular structure, with both oxygen atoms bonded to the vanadium atom, it would be called a “bidentate” structure. Detailed analysis of various orbital and electron states involved in monodentate and bidentate structures is beyond the scope of this application, and is not necessary in order to disclose and enable the use of improved catalysts for SO2-3 oxidation. However, such factors merit careful evaluation by chemists who study these types of catalytic materials in detail in an effort to create and screen alternate and possibly improved derivatives and analogs of the materials disclosed and suggested herein. Additional information on “peroxo-vanadate” compounds (i.e., complexes having unusually large numbers of oxygen atoms associated with vanadium atoms) is available in various articles, such as Won et al 1995 and other references cited therein.

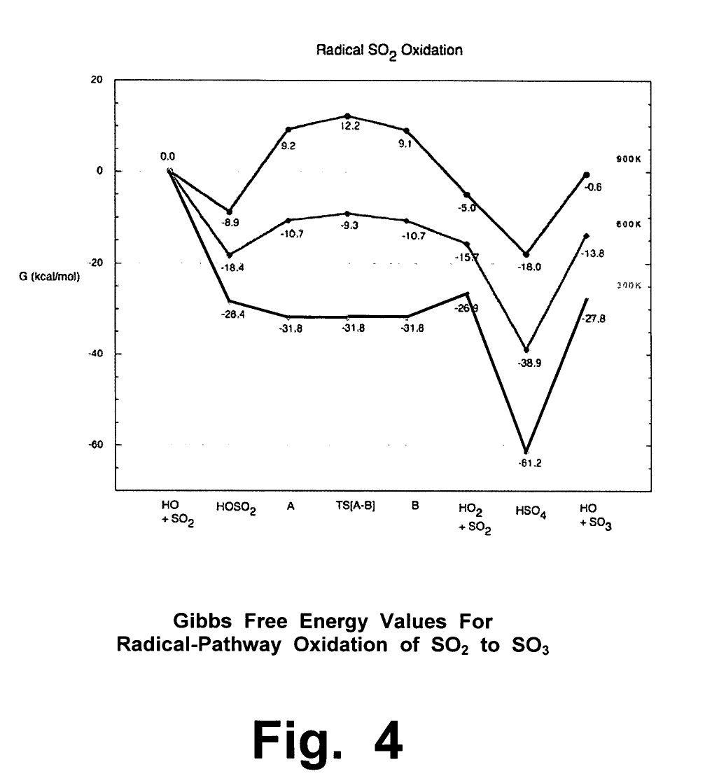

To aid in further analysis of the disclosures herein by chemists who specialize in this particular field of chemistry, two published items should also be consulted. Those items are Dunn et al 1998 (FIG. 11 is worth special note), Giakoumelou et al 209 (FIG. 4 and especially 4a is worth noting in particular).

As will be recognized by those skilled in this particular art, the use of computer modeling to identify a promising candidate catalyst does not lead inevitably to good performance, since factors such as fouling, increasing pressure drops as a function of the amount of time of use, and regeneration and replacement costs, all need to be studied and evaluated, during scaleup tests.

However, based on the computer modeling done to date, vanadium diformate and its halogenated analogs and derivatives appear to merit expedited evaluation to compare them against vanadium pentaoxide, and to determine whether they can lead to reduced overall costs for practical and efficient SO2-3 oxidation in the volumes and tonnages that will be relevant for methane conversion.

Additional candidate catalysts will be recognized by those skilled in the art who have considered and evaluated the disclosures herein. Any such candidate catalyst can be modeled and/or tested, using no more than routine experimentation and conventional modeling assumptions. Such candidate materials include, for example, per-bromo, per-chloro, and per-iodo analogs, as well as any other candidate catalysts that take vanadium to a +4, +5, or potentially +6 state, including compounds that replace the formate carbon atoms of the compounds described above with other electronegative atoms, such as nitrogen, sulfur, or phosphorus. In addition, various compounds that contain a peroxide bridge between two adjacent vanadium atoms will also merit consideration and modeling, and laboratory evaluation if the modeling results are promising.

Since formic acid derivatives with halogen atoms can be relatively unstable, chemists interested in such catalysts should evaluate articles such as Gilson 1995, and Li et al 1997, which describe methods for coating various candidate fluorine-containing materials onto solid supports.

In addition, catalytic chemists interested in this area of research should evaluate U.S. Pat. No. 2,418,851 (Rosenblatt et al 1947, assigned to Baker and Company). It disclosed that mixtures of platinum and palladium, coated onto supports, were more effective than either metal by itself, in converting SO₂ to SO₃. Accordingly, in view of the sizes and scales that will be involved in methane to methanol conversion, mixtures of various “soft” and/or “noble” metals (including vanadium) should be tested, to evaluate their efficacy in catalyzing SO₂ to SO₃ conversion on monolithic, stranded, or similar supports.

Catalytic chemists working in this particular field should also evaluate U.S. Pat. No. 6,500,402, (Winkler et al 2002, assigned to Metallgeselschaft AG of Germany). This patent discloses that relatively inexpensive iron catalysts can be used to convert SO₂ to SO₃ at relatively high temperatures, greater than 700° C. This temperature range is higher than can be withstood continuously by most soft and/or noble metals; accordingly, it is of substantial interest. Although the highest reported yield was 77% (see Table 1, in column 3 of the '402 patent), that type of yield may be sufficient for continuous operations, if the output streams are continuously separated, and if any unreacted SO₂ is returned to the reactor for another pass. That type of rough “first-pass” processing may be able to get most of the work done in a relatively inexpensive manner, in ways that can be supported and supplemented by “polishing” steps that will take the output yields to higher levels and percentages, using smaller quantities of more expensive catalysts.

Accordingly, the final choice of a preferred catalyst (or combination of catalysts) will be determined by efficiency levels and economic results, which in turn will depend on factors that can be controlled and optimized for various different operating conditions. It must also be recognized that because of various factors (including economies of scale, transportation costs, the costs of ensuring that backup supplies are reliably available in remote and/or hostile regions, etc.), different catalyst formulations may be preferred for installations in various different regions of the world.

Candidate Catalysts: Tungsten and Other +4/+6 Compounds

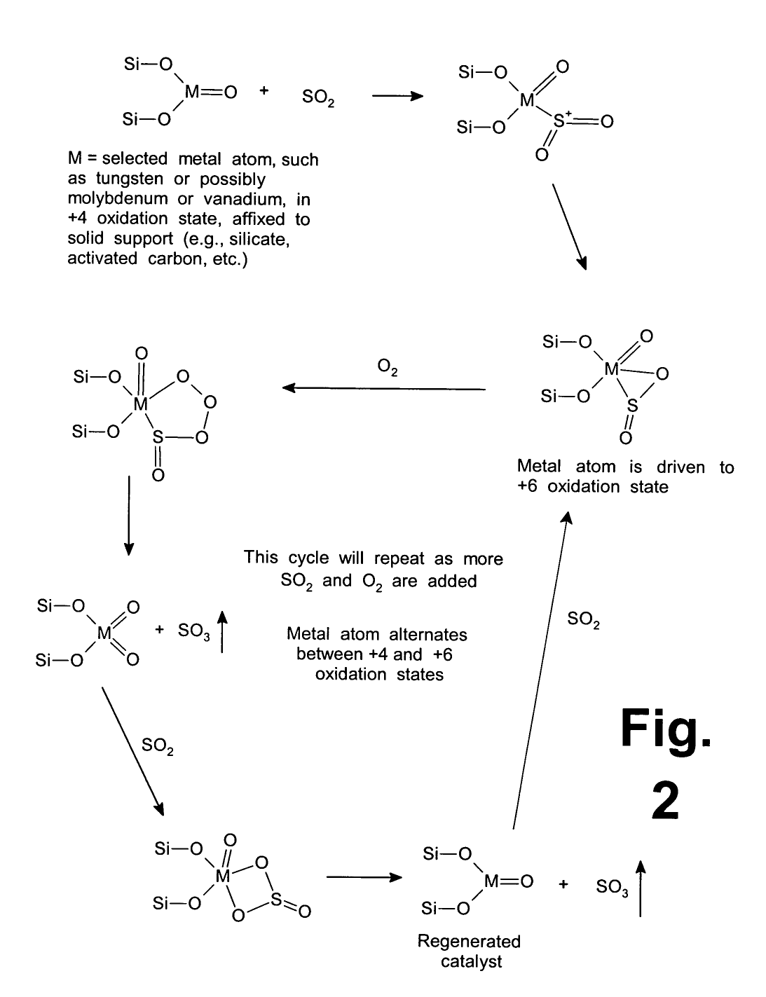

Another class of candidate catalysts that have shown very good promise in computer modeling includes transition metals that can be “driven” to an oxidation state of at least +4 and preferably even +6. The best modeling results seen to date have involved tungsten oxide derivatives, which can participate in catalytic cycles such as illustrated in FIG. 2, where M represents a metal atom such as tungsten.

The simplified molecular structure in the upper left corner of FIG. 2 depicts a metal oxide group in a +4 oxidation state, on the surface of a silicate support. Other types of solid supports, including aluminosilicates, activated carbon (and possibly various other hydrophobic forms of carbon), etc., can also be evaluated for such use.

In the first step of the reaction, a molecule of SO₂ is adsorbed on the catalytic surface. This drives the metal atom to a +5 oxidation state.

In the next step, the complex rearranges to form a transition state that drives the metal atom to a +6 oxidation state. The three-membered ring that contains the metal, sulfur, and oxygen atoms is stressed, due to the acute bond angles.

As additional oxygen (in the form of “dioxygen”, O₂) is added to the reactor, the oxygen will attacked the stressed triangular group, and will insert one or two additional oxygen atoms into the triangular ring, thereby creating a larger ring with less acute (and therefore less stressed) bond angles.

Because the sulfur atom is strongly electronegative, it will pull electrons in the bonds of the ring toward itself. This will cause the ring to rearrange and then detach from the metal atom, in a manner that releases SO₃ from the metal atom.

When SO₃ detaches, it leaves behind one of the three oxygen atoms from the expanded ring structure. The oxygen atom that is left behind is attached to the metal atom. In combination with the other oxygen atoms that are also attached to the metal atom, this leaves the metal atom in a +6 oxidation state.

As additional SO₂ is passed over the catalyst, it will be adsorbed to the “activated” metal atom on the catalyst. The resulting complex can then rearrange in a way that will allow the sulfur oxide group to detach. This will take the “surplus” oxygen atom away from the metal atom (thereby releasing SO₃), and it allows the metal atom to return to the +4 oxidation state, thereby regenerating the catalyst, which will repeat the cycle as additional SO₂ is attracted to the metal atom.

Variations on this process can be evaluated if desired, and may lead to enhancements. For example, transition metals that have various similarities to tungsten or molybdenum merit early evaluation for such use. Such metals include metals that are in certain “columns” of the periodic table, including:

(1) the 5b column, which includes vanadium (atomic symbol V). This column also includes niobium (Nb) and tantalum (Ta), but those metals are rarer and more expensive than vanadium.

(2) the 6b column, which includes chromium (Cr), molybdenum (Mo), and tungsten (W);

(3) the 7b column, which includes manganese (Mn); it also includes technicium (Tc) and rhenium (Re), but those are relatively rare and expensive;

(4) the 8 column, which includes iron (Fe); it also includes ruthenium (Ru) and osmium (Os), but those are relatively rare and expensive.

Other “transition metal” columns in the period table (including the 4b column, which includes titanium, and the 9 through 12 columns, which are headed by cobalt, nickel, copper, and zinc and which include various soft and/or “noble” metals such as palladium, silver, platinum, and gold) may also merit testing and evaluation for use as described herein; however, based on the computer modeling done to date, the Applicant's belief at this time is that the most promising metal catalysts include metals that can assume a +6 oxidation state. This includes metals such as iron, which normally will remain in a +2 or +3 oxidation state under most conditions, but which can be “driven” to a +6 oxidation state, if properly derivatized and placed under pressure-temperature combinations that can be achieved in oil and gas processing.

It also must also be recognized that any such metal atom will not act alone, and instead will be in a molecular structure, complex, or derivatized form that will determine its oxidation state. Accordingly, any derivatizing compounds having a history of successful catalytic performance in analogous processes can be evaluated for use as described herein, and formic acid derivatives (including substituted diformate compounds, such as chloro- or fluoro-diformate compounds) merit particular attention.

In carrying out such evaluations, it should be noted that methods and machines have been developed for screening large numbers of candidate catalyst formulations, in a rapid and automated manner. These methods and machines are described in articles such as Muller et al 2003, and other articles cited therein. Such devices use, for example: (i) reactors with multiple parallel tubes, each tube containing a different candidate catalyst, or (ii) titer plates with multiple wells, each well containing a candidate catalyst. When a certain reagent is passed through or loaded into all of the tubes or wells, the product generated by each individual tube or well (and therefore by each candidate catalyst) is collected separately, and delivered to an automated analytical device, such as a mass spectrometer or chromatograph. The tubes or wells that created the highest yields of the desired compound can be identified, and the exact content of the catalysts in any tubes or wells that resulted in good and desirable yields can be identified and studied more closely. For example, the best-performing candidate catalyst from one round of tests can be used as a “baseline” or “centerpoint” material, in a subsequent round of tests that will use variants that resemble the best-performing catalyst from the previous round of screening. Those variants can include known and controlled compounds, having exact compositions; alternately or additionally, “combinatorial chemistry” methods and reagents can be used to generate random or semi-random variants of a material that provided good results in an earlier screening test. Accordingly, these types of automated screening systems offer powerful and useful tools for rapidly identifying and/or improving catalyst formulations that can efficiently promote SO2-3 oxidation.

Various solid supports (such as silicates, aluminosilicates, activated or other hydrophobic carbon, etc.) can be evaluated for such use, and various types of solvents and/or “releasing agents” (such as supercritical carbon dioxide) can also be evaluated for such use.

Catalytic processing that uses two or more different types of catalysts also merits evaluation. For example, iron catalysts tend to be less efficient than other catalysts that contain more expensive metals; however, iron catalysts are relatively inexpensive, and they often can operate at temperatures that are too high for more expensive metals. Therefore, an economically preferred and useful processing system might use a first-stage reactor with an iron or other low-cost catalyst to achieve a “rough” or “first-pass” conversion (such as, for example, with yields in the range of about 40 to 80 percent), followed by a second-stage reactor that contains a more expensive catalyst, which can provide higher yields.

It also should also be noted that combinations of catalytic materials can be mixed and included in a single reactor vessel. As examples of this approach, U.S. Pat. No. 6,596,912 (Lunsford et al 2003) and Makri et al 2003 describe the use of catalysts containing manganese and sodium tungstate, on a silica support, in a different type of methane processing (“direct” processing of methane, in which methane gas is directly contacted with a catalyst, at high temperatures, to form higher hydrocarbons).

In addition to the foregoing comments, the Applicant herein asserts that another important article, Minhas and Carberry 1969, has not received adequate attention by companies that run systems that oxidize SO₂ to SO₃. That article, which mainly discusses reaction kinetics that were calculated in computerized simulations, contains various comments which apparently have not been accepted and utilized by companies and researchers working in this field, but which might be adapted in beneficial ways to optimize and reduce the costs of SO₂ oxidation. A detailed analysis of those theoretical calculations, and their potential implications in the system proposed herein, is beyond the scope of this application; however, that article merits close and careful attention by any chemists working specifically on improved methods and catalysts for oxidizing SO₂ to SO₃.

Manganese as a Candidate Catalyst for Splitting O2 Molecules

Nature (and photosynthesis in particular) offers lessons and examples that can help guide the development of highly efficient catalytic materials for use as disclosed herein, especially for oxidation reactions, including SO2-3 oxidation.

Photosynthesis evolved over billions of years in ways that render it remarkably efficient in breaking apart O₂ molecules, in ways that allow the resulting “activated” oxygen atoms to be to assemble larger molecules. The atomic and subatomic processes involved in these reactions have been given names such as “proton-coupled electron transfer” (PCET), or “hydrogen atom transfer” (HAT), as discussed in articles such as Tommos et al 1998, Westphal et al 2000, and Cukier 2002.

When studying photosynthesis, an important factor to note is that manganese is heavily involved in splitting apart O₂, to release and “activate” the two oxygen atoms (often called “singlet” oxygens) in each molecule of “dioxygen” (O₂). In the chloroplast structures that carry out photosynthesis in plants, manganese atoms are grouped together into “tetra-manganese clusters”, with each cluster containing four manganese atoms connected to each other by “bridges” formed by oxygen atoms. These tetra-manganese clusters are illustrated in FIG. 4 of Tommos et al 1998, FIG. 1 of Westphal et al 2000, and FIG. 1 of Cukier 2002.

This application is not an appropriate forum for a detailed analysis of how manganese helps plants carry out photosynthesis, since that information is very complex, and is already available in published articles such as cited above. However, it is specifically noted and disclosed herein that solid-supported catalysts that contain manganese and oxygen (and possibly other elements, such as tungsten, molybdenum, etc.) are likely to be able to emulate the highly efficient mechanisms of photosynthesis, in ways that can be adapted to increase the rates and yields of chemical processing as disclosed herein.

In addition and for similar reasons, it also is disclosed herein that solid-supported catalytic surfaces containing manganese (and possibly other catalytic metals, such as tungsten, molybdenum, etc.) are likely to offer substantial improvements in photovoltaic materials that can convert sunlight or other radiation into electrical voltage and current. This is a separate field of research that merits and needs attention in its own right. Even though photovoltaic materials do not directly relate to the chemical processing of hydrocarbons as disclosed herein, the insights and computer modeling that have been performed to date on candidate catalysts for performing certain types of oxygen activations and transfers, in chemical processing, may have laid the groundwork for developing advanced catalytic materials into photovoltaic materials that are more efficient than have ever been available under the prior art.

Radical-Initiated SO2-3 Conversion

Another very different candidate pathway also is disclosed herein for SO2-3 oxidation. Based on computer modeling, this pathway offers good promise for providing efficient and low-cost conversion of large volumes at high concentrations.

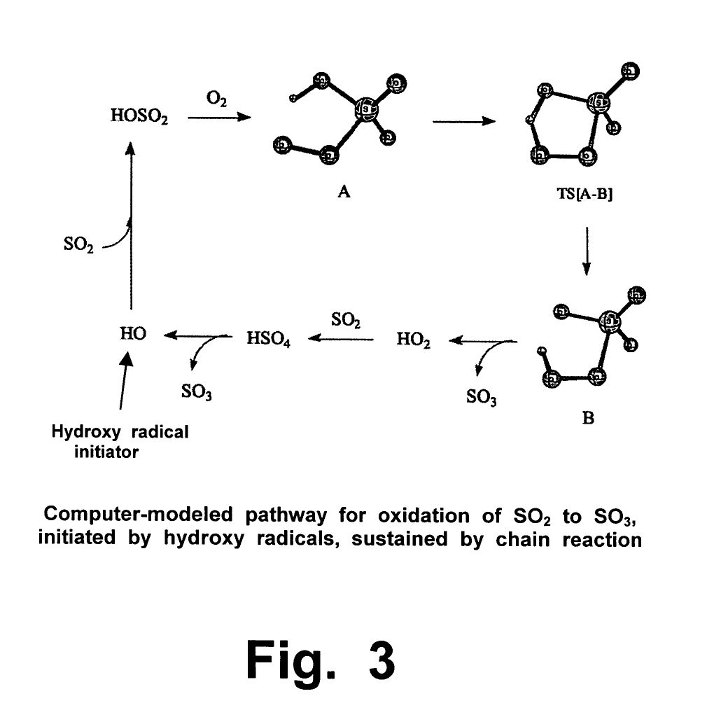

As illustrated in a cycle that begins in the lower left corner of FIG. 3, this pathway is set in motion by contacting SO₂ with hydroxy radicals, which can be provided by using UV or laser radiation, or heat, to activate an initiator compound. Hydrogen peroxide can be used as the initiator compound, if desired, but it usually is accompanied by water, which is likely to lead to the production of sulfuric acid wastes; accordingly, various other types of hydroxy-releasing initiator compounds that can sustain anhydrous conditions can be used, to avoid or minimize the creation of sulfuric acid. Such candidate compounds can include, for example, organic di-hydroxy groups (often referred to as di-alcohols or diols), triols (such as glycerin, also called glycerol), etc.

The hydroxy radicals will bind to the SO₂, creating HOSO₂ radicals. Additional oxygen (O₂) will bond to the HOSO₂ radicals, creating a radical complex with the formula HO(O₂)SO₂, initially as a transitional state A, shown at the top of FIG. 3. This transitional state A will then go through a rearrangement, where the pendant hydrogen proton initially will form cyclic intermediate TS[A-B] shown in FIG. 3, and then move to the dioxygen group, forming transitional state B. The HOO group will split off from the SO₃, thereby releasing a first molecule of stable SO₃ as well as an unstable and highly reactive HO₂ radical. The HO₂ radical can bond to another molecule of SO₂, thereby creating another radical intermediate, HSO₄, which is effectively a sulfuric acid radical.

If water is present in the system, sulfuric acid radicals can remove a hydrogen atom from the water, thereby forming stable sulfuric acid, which can be processed via any of various means. If water is not present in the system, and if an appropriate catalyst is present (such as titanium dioxide, TiO₂, which is known to help split hydroxy groups off of water; other titania compounds also offer good candidates for early evaluation), the sulfuric acid radical can instead be induced to split apart, in a way that releases stable SO₃. The splitting of HSO₄ will also release new hydroxy radicals, thereby sustaining the chain reaction and returning to the lower left corner of FIG. 3.

The splitting of HSO₄ into stable SO₃ and hydroxy radicals is an energy-consuming step; however, as illustrated in FIG. 4, which shows Gibbs free energy calculations for each step of the process, at three different temperatures (300, 600, and 900° Kelvin), that step requires about the same amount of energy that is released by the preceding reaction, in which HO₂ radicals bind to SO₂, and the overall reaction system appears to be favorable and feasible, especially if anhydrous conditions can be sustained.

Heat-Exchanger use of Released Energy

As mentioned above, SO2-3 oxidation is highly exothermic, and releases large quantities of heat. At least some of that heat must be removed from the reactor, to prevent unwanted reactions that might impede the efficiency of the conversion reactions, or damage the equipment or catalytic material.

Within a larger methane-processing system, the methane-sulfonic acid (MSA) that emerges from a methane-to-MSA reactor is likely to be substantially cooler than the preferred temperatures for cracking or processing the MSA.

Therefore, a heat exchange system is disclosed that allows heat energy released by SO2-3 0oxidation to be transferred into the liquid MSA. This can heat up the MSA, to get it closer to cracking temperatures, while also drawing heat away from the SO₂ reactor, to keep it at an optimal temperature.

This can be done, in a simple and direct manner, by placing the SO2-3 reactor inside a tube that is surrounded by an annular flow channel that will carry liquid MSA, preferably in a counterflow direction. If desired, the SO2-3 reactor tube can have an elliptical, rectangular, or other noncircular cross-sectional shape, to increase the heat-transferring surface area, and the annular flow channel can be provided with internal fins or other structures to increase heat transfer rates.

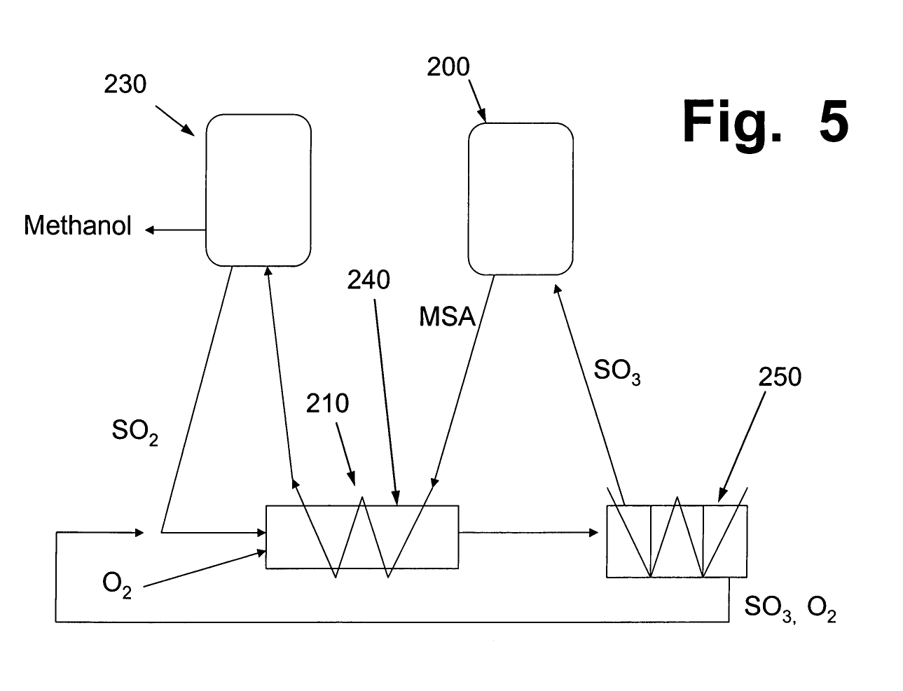

Accordingly, FIG. 5 is a schematic layout depicting some of the major pieces of equipment that can be used to efficiently oxidize SO₂ to SO₃, as part of a methane-to-methanol manufacturing facility. This system depicts MSA reactor 200, shown near the top center of FIG. 5, which will operate as described in PCT application WO 2004/041399. It will be continuously supplied with methane and SO₃, along with “makeup” quantities of a radical initiator. The radicals will trigger a chain reaction that causes the methane to bond to the SO₃, thereby creating MSA.

The MSA will emerge from reactor 200 at a temperature that is likely to be in the range of about 50 to 100° C. The MSA will be sent to the outer (annular) “sleeve” passageway of heat exchanger 210, which is effectively wrapped around an internal SO2-3 oxidation reactor 240, in a counterflow direction. The MSA will emerge from the heat exchanger 210 and will be sent to a cracking reactor 230 (or any other type of MSA processing reactor) at a substantially hotter temperature, which in many cases is likely to be in the range of about 300 to 350° C., which is at or close to the cracking temperature of the MSA.

It must be emphasized that those temperature estimates are merely illustrative, and hotter temperatures are likely to be used or encountered at many facilities, since methane gas that is emerging from a wellhead or a gas-oil separator is often relatively hot, due to geological factors and to the fact that gas-oil separation can be carried out more rapidly and efficiently at elevated temperatures. The essential point is to note that MSA will be created at a temperature lower than the cracking temperature, and it will need to be heated up, to enable it to be cracked efficiently and economically, to release methanol and SO₂. Since the SO₂ to SO₃ oxidation reaction will be releasing large amounts of heat, which will need to be dissipated and removed in order to protect the oxidation catalyst and keep the process running smoothly and continuously, a heat exchanger that uses heat from the oxidation process, to heat the MSA up to a temperature which is at or near its cracking temperatures, provides an ideal way to remove and efficiently utilize the heat that is being released by the SO₂ oxidation reaction.

When the heated MSA reaches the MSA cracking reactor 230 (which presumably will contain a catalyst, such as a Zeolite), the MSA will be broken apart in a way that releases methanol and SO₂. The methanol is the desired product, from the methane. Since it is a relatively stable liquid at room temperature, it can be sent to a storage tank or pipeline, for shipping to some other location, or it can be used in any other appropriate way (such as a feedstock for some other chemical reaction), depending on the particular types of facilities available at that site.

The cracking reaction will also release SO₂, which will be sent to the catalytic oxidizer 240, as described above. Oxygen will also need to be added to the catalytic oxidizer. The oxygen can be in the form of unprocessed air (i.e., directly from the atmosphere, with a purity of about 20% oxygen, 80% nitrogen, and “parts per million” (ppm) quantities of other gases, including carbon dioxide), compressed to any desired level. Alternately, using equipment such as pressure swing absorbers, atmospheric oxygen can be enriched to any desired level, including purity levels that approach 100%. Such devices are well-known, and a decision to use or not use oxygen enrichment processing will be an economic rather than technical decision, depending on economies of scale and other factors that will apply at some particular site.

For simplicity, a single catalytic oxidizer 240 is shown in FIG. 3, and a site can be run with such a system, if desired, if unreacted SO₂ is separated from the downstream output, and recycled back through the oxidizer vessel. Alternately, sites also can be designed with a plurality of staged oxidizer vessels, using different types of catalysts if desired. For example, as mentioned above, relatively inexpensive iron catalysts can be used to achieve roughly 80% conversion of SO₂ to SO₃, while more expensive catalysts can achieve higher conversion levels. Accordingly, a process stream and facility can be designed that will use inexpensive catalysts in one or more “first pass” oxidizer vessels that will handle the bulk of the conversion, while more expensive catalysts in “polishing” units will extend the process and carry it to higher SO₃ output levels.

With regard to the catalytic oxidizer, anyone studying the literature should recognize that two important terms are not always used consistently, and may be used in different manners, by different experts, when applied to equipment such as described herein and illustrated in FIG. 3. Those two terms are “adiabatic” and “isothermal”.

The term “adiabatic” indicates that an external source of heat (or cooling) is not being used, to add heat to, or to remove heat from, a certain system. However, questions can arise as to which pieces of equipment are included in the “system” that is being analyzed. If the “system” is defined to include only the reactor vessel that contains the catalyst and carries out the oxidation reaction, then clearly, that system is not adiabatic, since a heat exchanger will be actively working to remove heat from that “system”. However, if the “system” is defined to include not just the reactor vessel, but also the heat exchanger that works with it, then that “system” is indeed adiabatic.

Similarly, the term “isothermal” indicates that a “system” is operating at a constant temperature; however, once again, the “system” needs to be defined, in order to determine whether that term will validly apply to this type of equipment and operation. The temperature in the oxidizing reactor will not be constant, throughout the length of the vessel; instead, the entering reagents will be relatively cool, and the exiting products will be relatively hot. Therefore, under one possible use of the term, the system is not isothermal. However, under a different use and interpretation of the term “isothermal”, the system normally will be operating at steady-state and unchanging temperature conditions. Accordingly, some people might refer to that condition as being isothermal.

Accordingly, both of those terms can be used in ways that can be inconsistent and misleading, and any readers who are studying the literature or patents in this field should be careful about relying heavily on either those terms, and should try to determine how either term is being used by a particular author or inventor.

When the relatively hot mixture of products exits the catalytic oxidizer 240, it will be in gaseous form, and will contain a mixture of SO₃ (the desired product), unreacted SO₂, and unreacted O2. In addition, if unprocessed air was used as the source of the oxygen, the output gas also will contain a relatively large amount of inert N₂ gas (which forms roughly 80% of the atmosphere), and trace quantities of carbon dioxide and certain other gases found in the atmosphere.

This hot output gas mixture is passed through a condenser system 250, which will cool the mixture. The first compound that will condense into a liquid is SO₃, which is the heaviest molecule in the gas. To increase the efficiency of the condensation reaction, a multi-stage condensation reactor can be used, which will allow some portion of the SO₃ to begin dropping out of the flowing gas stream so that it can be collected somewhere fairly near the entry point, and additional portions of the SO₃ to drop out of the flowing gas stream at one or more additional collection points. This type of multi-stage condensation is well known, and takes advantage of a major feature of any equilibrium-seeking reaction (i.e., if one product of an equilibrium-seeking reaction is continuously being removed from the system, then the equilibrium-seeking reaction will keep pushing more molecules in that direction, to try to reach and sustain the desired equilibrium balance point).

The liquid SO₃ that is collected and removed from the condenser vessel 250 is sent to the MSA-forming reactor.

After SO₃ has been removed from the gas stream in the condenser 250, the output gas will contain some level of unreacted SO₂, some level of unreacted O₂, and some level of N₂, carbon dioxide, etc. This output gas can be passed through a second condenser, a gas separator (which can use a molecular sieve, a spinning centrifugal unit, or any other suitable type of device or combination of devices), or any other suitable type of system or device that can effectively separate the SO₂ (or a substantial portion thereof, in either gaseous or liquid form, from the O₂ and/or N₂ gases. The SO₂ can then be returned to one or more catalytic oxidizer vessels, for another pass. This type of recycling and/or advanced processing can increase the total output yields of the overall oxidation process, to maximize the continuous reuse and recycling of the sulfur, and to minimize the formation of unwanted waste products.

Thus, there has been shown and described a new and useful means for efficient oxidation of SO₂ to SO₃, for use in methane processing and other high-concentration manufacturing operations. Although this invention has been exemplified for purposes of illustration and description by reference to certain specific embodiments, it will be apparent to those skilled in the art that various modifications, alterations, and equivalents of the illustrated examples are possible. Any such changes which derive directly from the teachings herein, and which do not depart from the spirit and scope of the invention, are deemed to be covered by this invention.

### REFERENCES

Bal'zhinimaev, B. S., et al, Chemical Engineering Journal 91: 175-179 (2003)

Basickes, N., et al, “Radical-initiated funcionalization of methane and ethane in fuming sulfuric acid,” J Am Chem Soc 118: 13111-13112 (1996)

Cuckier, R. I., “A Theory that Connects Proton-Coupled Electron-Transfer and Hydrogen-Atom Transfer Reactions,” J Phys Chem B 106: 1746-57 (2002)

Davtyan, O., et al, Doklady Akademii Nauk SSSR 104: 857 (1955)

Dunn, J. P., et al, “Oxidation of sulfur dioxide to sulfur trioxide over supported vanadia catalysts,” Applied Catalysis B: Environmental 19: 103-17 (1998)

Fonseca, I. M., Catalysis Today 78: 203 (2003)

Giakoumelou, I., et al, Catalysis Letters 78: 209 (2002)

Gilson, T. R., J Solid State Chemistry 117: 136 (1995)

Golombok, M., et al, “A chemical alternative to natural gas flaring,” Ind Eng Chem Res 42: 5003-5006 (2003)

Handzlik, Jr., et al, J of Molecular Catalysis A: Chemical 175: 215-25 (2001)

Hayes, R. E., et al, Introduction to Catalytic Combustion (Gordon & Breach Science Publ., Amsterdam, 1997)

Li, P., et al, Surface Science 380: 530 (1997)

Libby, M. C., et al, “Synthesis of Ketenes with Oxide Catalysts,” Ind Eng Chem Res 33: 2904-12 (1994)

Lobree, L. J., et al, “K2S2O2-initiated sulfonation of methane to methanesulfonic acid,” Ind Eng Chem Res 40: 736-742 (2001)

Makri, M., et al, “Successful scale up of gas recycle reactor-separators for the production of C2H4 from CH4,” Applied Catalysis A: General 244: 301-10 (2003)

Minhas, S. and Carberry, J. J., “Adiabatic catalytic reactor simulation—the oxidation of SO2”, British Chem Engr 14: 799 (1969)

Mukhopadhyay, S., et al, “Effects of solvent acidity on the free-radical-initiated synthesis of methanesulfonic acid from CH4 and SO3,” American Chemical Society 2002: A-E (2002)

Mukhopadhyay, S., et al, “A novel method for the direct sulfonation of CH4 with SO3 in the presence of KO2 and a promoter,” Organic Process Research & Development 2003: A-D (2003)

Mukhopadhyay, S., et al, “A high-yield approach to the sulfonation of methane to methanesulfonic acid initiated by H2O2 and a metal chloride,” Angew Chem Int Ed 42: 2990-2993 (2003)

Mukhopadhyay, S., et al, “Effects of solvent acidity on the free-radical-initiated synthesis of methanesulfonic acid from CH4 and SO3,” Amer Chem Soc 2002: A-E (2002)

Muller, A., et al, Catalysis Today 81: 337 (2003)

Pak, S., et al, “Elementary Reactions in the Oxidative Coupling of Methane over Mn/Na2WO4/SiO2 and Mn/Na2WO4/MgO Catalysts,” J of Catalysis 179: 222-30 (1998)

Periana, R. A., et al, “A mercury-catalyzed, high-yield system for the oxidation of methane to methanol,” Science 259: 340 (1993)

Pyatnitskii, Y. I., “Contemporary Methods for the Direct Catalytic Conversion of Methane,” Theoretical and Experimental Chemistry 39(4): 201-18 (2003)

Raja, L. L., et al, Catalysis Today 59: 47 (2000)

te Velde, G., et al, J Computational Chemistry 22: 931-967 (2001)

Tommos, C., et al “Oxygen Production in Nature: A Light-Driven Metalloradical Enzyme Process,” Acc Chem Res 31: 18-25 (1998)

Wang, D., et al, “Oxidative Coupling of Methane over Oxide-Supported Sodium-Manganese Catalysts,” J of Catalysis 155: 390-402 (1995)

Wang, X., et al, “Designing the activity/selectivity of surface acidic, basic and redox active sites in the supported K2O-V2O5/Al2O3 catalytic system,” Catalysis Today 96: 211-22 (2004)

Waters, T., et al, “Catalytic gas phase dehydration of acetic acid to ketene,” International J of Mass Spectrometry 228: 599-611 (2003)

Westphal, K. L., et al, “Concerted hydrogen-atom abstraction in photosynthetic water oxidation,” Current Opinions in Plant Biology 3: 236 (2000)

Won, T-J., et al, Inorganic Chemistry 34: 4499 (1995)

1. A method for oxidizing SO₂ at high concentration into SO₃, comprising the following steps:
a. contacting a gas containing SO₂ at a concentration of at least about 3% by weight, and a supply of O₂ molecules, with an activated carbon preparation that contains at least one type of catalytic metal dopant, in a reactor vessel that also contains at least one anhydrous liquid solvent having a low dielectric constant, under temperature and pressure conditions that promote oxidation of SO₂ molecules to form SO₃ molecules; and,
b. using said anhydrous liquid solvent having a low dielectric constant as a stripping agent to remove SO₃ molecules from the activated carbon preparation.

2. The method of claim 1 wherein the catalytic metal dopant comprises vanadium, tungsten, or molybdenum atoms.

3. The method of claim 1 wherein the anhydrous liquid solvent having a low dielectric constant is supercritical CO₂, supercritical SO₂, and methane-sulfonic acid.

4. The method of claim 1 wherein the anhydrous liquid solvent having a low dielectric constant is selected from the group consisting of supercritical SO₂, and methane-sulfonic acid.

5. A composition of matter for use in oxidizing SO₂ at high concentration into SO₃, comprising the following steps:
a. an activated carbon preparation that contains at least one type of catalytic metal dopant, and,
b. at least one anhydrous liquid solvent having a low dielectric constant, which is able to function as an effective stripping agent for removing SO₃ molecules from the activated carbon preparation.
